(19) United States
(12) Patent Application Publication
(10) Pub. No.: US 2025/0360776 A1
(43) Pub. Date: Nov. 27, 2025

(54) AIR CONDITIONING APPARATUS FOR A VEHICLE

(71) Applicants: HYUNDAI MOTOR COMPANY, Seoul (KR); KIA CORPORATION, Seoul (KR); HANON SYSTEMS, Daejeon (KR)

(72) Inventors: Eung Young Kim, Hwaseong-si (KR); Yoon Hyung Lee, Hwaseong-si (KR); Myung Hoe Kim, Hwaseong-si (KR); Jae Geun Jeong, Hwaseong-si (KR); Seung Ho Lee, Daejeon (KR); Sang Ki Lee, Daejeon (KR)

(73) Assignees: HYUNDAI MOTOR COMPANY, Seoul (KR); KIA CORPORATION, Seoul (KR); HANON SYSTEMS, Daejeon (KR)

(21) Appl. No.: 18/939,130

(22) Filed: Nov. 6, 2024

(30) Foreign Application Priority Data
May 27, 2024 (KR) 10-2024-0068459

(51) Int. Cl. B60H 1/24

(52) U.S. Cl. CPC B60H 1/241

(57) ABSTRACT

An air conditioning apparatus includes a case having an air inlet, an evaporator disposed toward the air inlet, a heating device disposed downstream of the evaporator, and a temperature control door installed between the evaporator and the heating device. The temperature control door is configured to adjust air flow downstream of the evaporator. The case includes a defrosting vent and a face vent sequentially arranged in a front-to-rear direction of the case and includes a floor vent formed between the defrosting vent and the face vent on at least one of left and right side walls of the case.

### CROSS-REFERENCE TO RELATED APPLICATION(S)

This application claims benefit of priority to Korean Patent Application No. 10-2024-0068459 filed on May 27, 2024, in the Korean Intellectual Property Office, the disclosure of which is incorporated herein by reference in its entirety.

### TECHNICAL FIELD

The present disclosure relates to an air conditioning apparatus for a vehicle having a reduced size and weight and reduced production costs.

### BACKGROUND

In general, an air conditioning apparatus for a vehicle is configured to cool or heat a vehicle interior by allowing outdoor air introduced into the vehicle interior by a blower to selectively pass through an evaporator or a heater through which refrigerant flows to exchange heat. The outdoor air in a cold or warm state is then distributed through a defrosting vent, a face vent, and a floor vent that are in communication with respective portions of the vehicle interior.

For example, in a case of the air conditioning apparatus, an evaporator and a heater are disposed downstream of an air inlet, and a temperature control door is provided between the evaporator and the heater to allow air to selectively flow through a cooling flow path and a heating flow path. In addition, an upper portion of the case has a defrosting door, a face door, a floor door, and the like to allow or regulate the flow of cold air from the cooling flow path, warm air from the heating flow path, or a mixture thereof to a defrosting vent, a face vent, a floor vent, and the like.

For the floor door, an additional partition wall surrounding the floor door needs to be installed in the case, thereby increasing a size and a weight of the air conditioning apparatus, resulting in an increase in production costs. In addition, due to the installation of the partition wall, resistance to air flow in the case increases, and accordingly, noise and power consumption increase, leading to a degradation in product quality.

### SUMMARY

An aspect of the present disclosure provides an air conditioning apparatus for a vehicle having a reduced a size and weight and reduced production costs by changing an arrangement of a door provided in a case and removing a partition wall.

In addition, another aspect of the present disclosure provides an air conditioning apparatus for a vehicle that produces less noise, reduces power consumption, and improves product quality by reducing resistance to air flow in the case.

According to an aspect of the present disclosure, an air conditioning apparatus is provided that includes a case having an air inlet, an evaporator, a heating device disposed downstream of the evaporator, and a temperature control door installed between the evaporator and the heating device and configured to adjust air flow downstream of the evaporator. The case may include a defrosting vent and a face vent sequentially arranged in a front-to-rear direction of the case. The case may also include a floor vent formed between the defrosting vent and the face vent on at least one of a left or a right side wall of the case.

The case may include a floor door installed on the floor vent. The floor vent may be disposed downstream of the evaporator and the heating device.

The floor door may include a rotating shaft passing through the floor vent and rotatably installed, and a door body rotating according to rotation of the rotating shaft. The rotating shaft may be disposed to extend in the front-to-rear direction.

The air conditioning apparatus may further include an actuator installed on an external surface of the case, a rotatable cam member connected to the actuator, and a lever rotatably installed on the external surface of the case and having one end connected to the floor door and the other end connected to the cam member.

The cam member may be fixedly connected to an output shaft of the actuator and rotates along with the output shaft. The cam member may have at least one cam groove having a trajectory.

The rotating shaft may include a fixed link fixed to the rotating shaft and extending from the rotating shaft and may include a connection link having one end hingedly connected to the fixed link. The other end of the connection link may be hingedly connected to the lever, such that the connection link may transmit, to the fixed link and the rotating shaft, a driving force transmitted from the lever.

The lever may include a lever body, a lever shaft provided in the middle of the lever body and connected to the case, a hinge portion provided at one end of the lever body and connected to the other end of the connection link, and a moving pin provided at the other end of the lever body and inserted into the cam groove to be movable along the cam groove.

The heating device, downstream of the evaporator, may define a heating flow path covered by the heating device and a cooling flow path without the heating device.

When the temperature control door opens an upstream portion of the heating device downstream of the evaporator, air, introduced into the case, may flow along the heating flow path. When the temperature control door closes the upstream portion of the heating device downstream of the evaporator, air, introduced into the case, may flow along the cooling flow path.

The floor door may be positioned upstream of the face vent in the heating flow path and may be positioned downstream of the face vent in the cooling flow path.

The case may include a defrosting door configured to adjust an amount or degree of opening of the defrosting vent and may include a vent door configured to adjust an amount or degree of opening of the face vent.

The temperature control door, the defrosting door, and the vent door may respectively include a drive shaft. A shaft line of the rotating shaft may intersect a shaft line of the drive shafts of the temperature control door, the defrosting door, and the vent door at a right angle.

At least one of the temperature control door, the defrosting door, or the vent door may be slidably installed. At least one of the temperature control door, the defrosting door, or the vent door may include a rack and pinion mechanism.

A floor duct may be connected to the floor vent. A floor flow path may be formed on the outside of the case.

The air inlet may be formed on a lower surface of the case. The evaporator may be disposed to be inclined with respect to the lower surface of the case.

According to embodiments of the present disclosure, an air conditioning apparatus for a vehicle may have a reduced size and weight, as compared to an air conditioning apparatus according to the related art, thereby reducing production costs.

In addition, according to embodiments of the present disclosure, a flow path may be minimized to reduce resistance to air flow in a case. Accordingly, an air volume may be increased, and noise and power consumption may be reduced, thereby improving product quality.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a perspective view of an air conditioning apparatus according to an example embodiment of the present disclosure;

FIG. 2 is a partially cut-away perspective view of a main portion of an air conditioning apparatus according to an example embodiment of the present disclosure;

FIG. 3 is a cross-sectional view of FIG. 1;

FIGS. 4A and 4B are perspective views of a floor door; and

FIG. 5 is a diagram illustrating operation of an air conditioning apparatus according to an example embodiment of the present disclosure.

### DETAILED DESCRIPTION

As used herein, a vehicle refers to various vehicles for transporting an object such as a person, animal, or another item, material, or thing from a starting point to a destination. Such vehicles are not limited to vehicles travelling on roads or tracks.

As used herein, the terms used in relation to direction, such as “front,” “rear,” “forward,” “rearward,” “left,” “right,” “upper,” “lower,” and the like, are defined based on a vehicle or a body of the vehicle.

The present disclosure proposes an air conditioning apparatus that is positioned in front of a crash pad (referred to as a dashboard) and installed in an interior of a vehicle to cool and/or heat the interior.

Hereinafter, embodiments of the present disclosure are described in detail with reference to the drawings. In adding reference numerals to components of each drawing, it should be noted that the same components are indicated by the same numerals even though displayed on different drawings. When a component, device, element, or the like of the present disclosure is described as having a purpose or performing an operation, function, or the like, the component, device, or element should be considered herein as being “configured to” meet that purpose or perform that operation or function.

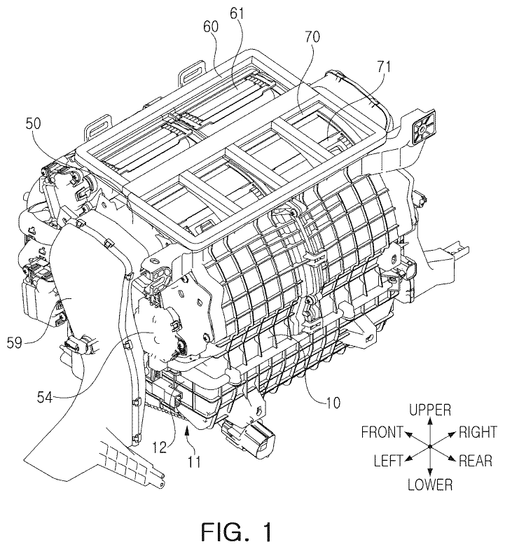

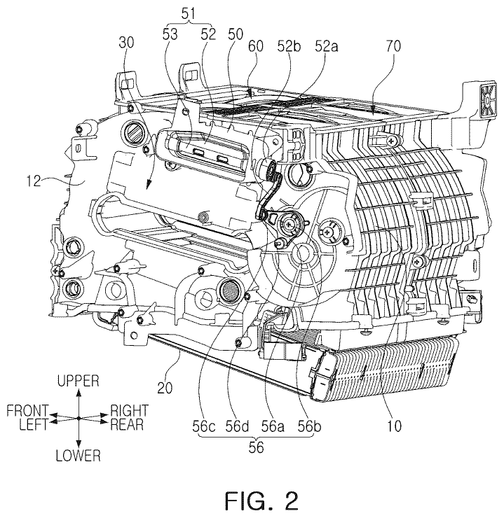

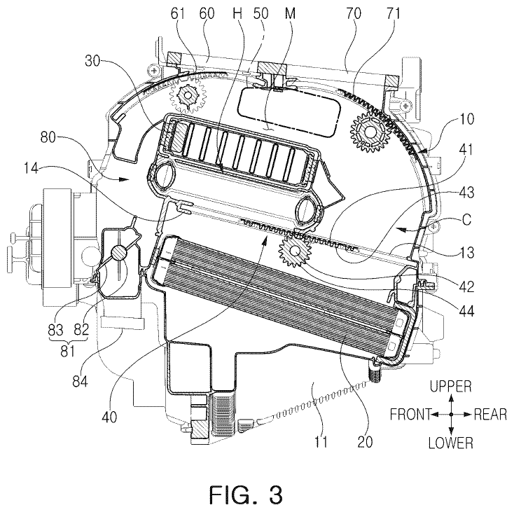

FIG. 1 is a perspective view of an air conditioning apparatus according to an example embodiment of the present disclosure. FIG. 2 is a partially cut-away perspective view of a main portion of an air conditioning apparatus according to an example embodiment of the present disclosure. FIG. 3 is a cross-sectional view of FIG. 1.

As illustrated in FIGS. 1-3, the air conditioning apparatus according to an example embodiment of the present disclosure may include a case 10, an evaporator 20, a heating device 30, and a temperature control door 40.

The case 10 may be formed by, for example, coupling symmetrical left and right case divisions to each other, such that the case 10 may have a substantially hexahedral cylindrical shape, but a shape and structure of the case are not necessarily limited thereto.

The case 10 may include an air inlet 11 through which outdoor air and/or indoor air is introduced. The air inlet may communicate with the outside of a vehicle interior to introduce outdoor air into the case 10. Additionally, the air inlet 11 may communicate with the vehicle interior to introduce air in the vehicle interior, in other words, indoor air into the case 10.

Optionally, a blower (not illustrated) may be disposed upstream of the air inlet 11 to suction outdoor air and/or indoor air and blow the suctioned air into the case 10 through the air inlet 11.

In the air conditioning apparatus according to an example embodiment of the present disclosure, the air inlet 11 may be formed, for example, on a lower surface of the case 10, but an arrangement of the air inlet is not necessarily limited thereto.

The evaporator 20 may be a heat exchanger for cooling, and may cool air, introduced from the air inlet 11 and flowing into the case 10. Refrigerant, flowing in the evaporator, and air, passing through the evaporator from the air inlet, may exchange heat with each other taking heat from the air while evaporating the refrigerant, and cooling the air. As a result, the air conditioning apparatus may supply cold air to the vehicle interior to perform cooling.

The heating device 30 may be disposed downstream of the evaporator 20, and may have a cross-sectional area, narrower than that of the evaporator. Downstream of the evaporator, a region covered by or corresponding to the heating device may be referred to as a heating flow path H, and a region without the heating device may be referred to as a cooling flow path C. In other words, the heating flow path and the cooling flow path may be defined or divided by the heating device, downstream of the evaporator.

The heating device 30 may be disposed in the heating flow path H and may heat air flowing along the heating flow path. Here, the heating device 30 may include a heater core through which high-temperature cooling water from an engine is circulated, an inner condenser included in a heat pump system of an electric vehicle, and/or a positive temperature coefficient (PTC) electric heater operated by electricity.

The temperature control door 40 may be installed between the evaporator 20 and the heating device 30. The temperature control door 40 may adjust a temperature of the air discharged from the air conditioning apparatus by adjusting an opening amount or degree, i.e., an open area of the cooling flow path C and the heating flow path H. Air, passing through the evaporator, may pass through the heating device or bypasses the heating device due to an arrangement of the temperature control door 40. Accordingly, an amount of air to be heated may be determined by an arrangement of the temperature control door 40.

Optionally, the temperature control door 40 may be slidably installed between the evaporator 20 and the heating device 30. To this end, the temperature control door may include a rack and pinion mechanism.

For example, the temperature control door 40 may include a door body 41 and a drive shaft 42. The door body may be in the form of a substantially flat plate and may have an area capable of closing the cooling flow path C or the heating flow path H. The drive shaft may be rotatably installed on opposite left and right side walls 12 of the case 10 and may be coupled to the door body to slidably move the door body.

In addition, a guide groove 13, slidably supporting and guiding opposite ends in a longitudinal direction (for example, leftward and rightward directions of the vehicle) of the door body 41, may be formed on internal surfaces of the opposite left and right side walls 12 of the case 10. In addition, an insertion groove 14 into which a corresponding opposing opposite end in a width direction (for example, a front-to-rear direction of the vehicle) end of the door body is inserted and supported during maximum cooling or maximum heating may be formed in the case 10.

A rack gear 43 or a gear groove may be formed on one surface of the door body 41 adjacent to the opposite ends in the longitudinal direction of the door body 41 to be engaged with the pinion gear 44 of the drive shaft 42. The rack gear or gear groove may be arranged and formed in a sliding direction of the door body.

Pinion gears 44 may be formed or coupled to opposite sides of the drive shaft 42 to be engaged with the rack gear 43 or the gear groove of the door body 41, respectively. One end of the drive shaft may pass through one sidewall 12 of the case 10 to be externally exposed. An actuator (not illustrated) including a motor may be connected to the exposed end to drive the drive shaft to rotate.

The door body 41 of the temperature control door 40 configured to be slidable as described above, may move within a range in which the cooling flow path C or the heating flow path H is completely open and the cooling flow path or heating flow path is completely closed.

For example, during maximum cooling, the door body 41 may be moved to completely open the cooling flow path C and to completely close the heating flow path H. Accordingly, air, introduced into the air inlet 11, may all flow along the cooling flow path and bypass the heating device 30.

Conversely, during maximum heating, the door body 41 may be moved to completely open the heating flow path H and to completely close the cooling flow path C. Accordingly, air, introduced into the air inlet 11, may all flow along the heating flow path and pass through the heating device 30.

In addition, in a mixing mode, the door body 41 may be moved by rotation of the drive shaft 42 to partially open each of the cooling flow path C and the heating flow path H. Accordingly, air, introduced into the air inlet 11, may pass through the evaporator 20. Then the temperature control door 40 may allow part of the air to flow along the cooling flow path and part of the air to flow along the heating flow path 30 and pass through the heating device 30.

Air passing through the cooling flow path C, in other words, cold air, and air passing through the heating flow path H, i.e., warm air, may be mixed with each other in a mixing region M in the case 10 to generate mixed air.

As described, air flow may be adjusted downstream of the evaporator 20 according to a degree to which the temperature control door 40 opens one of the cooling flow path C and the heating flow path H and closes the other one of the cooling flow path C and the heating flow path H. This may adjust a temperature of air discharged from the air conditioning apparatus.

Here, a configuration and an operation relationship of the temperature control door 40 is not necessarily limited to the above-described example. The temperature control door 40 may have any other configuration and thus may operate in a different manner.

In addition, the case 10 may include a defrosting vent 60 and a face vent 70 arranged side by side in a front-to-rear direction on an upper surface thereof. The defrosting vent may be for discharging air toward windshield glass of the vehicle and the face vent may be for discharging air toward upper bodies of passengers seated in the front seats in the vehicle interior.

In addition, a defrosting door 61, adjusting an opening amount or degree of the defrosting vent 60, and a vent door 71, adjusting an opening amount or degree of the face vent 70, may be provided in the case 10.

Optionally, the defrosting door 61 and the vent door 71 may be slidably installed in the defrosting vent 60 and the face vent 70, respectively. To this end, the defrosting door and the vent door may include a door body, a drive shaft, and a rack and a pinion mechanism in a similar manner to the temperature control door 40.

In addition, one end of each drive shaft may pass through one side wall 12 of the case 10 to be externally exposed. For example, an actuator (not illustrated) including a motor may be connected to the exposed end to drive the drive shaft to rotate.

Here, configurations and an operation relationship of the defrosting door 61 and the vent door 71 are not necessarily limited to the above-described and illustrated examples. The defrosting door 61 and the vent door 71 may have any other configuration and thus may operate in a different manner. For example, the defrosting door and the vent door may include a rotating shaft, respectively, and may be rotatably installed in corresponding vents, respectively.

The case 10 may further include a rear seat flow path 80 formed to discharge air toward a rear seat of the vehicle interior. The rear seat flow path may be positioned in front of the case and may include an opening/closing door 81 adjusting at least an amount of opening of the rear seat flow path.

Optionally, the opening/closing door 81 may be rotatably installed in the case 10. To this end, the door/closing door may include a rotating shaft 82 rotatably installed in the case and a plate 83 rotating according to rotation of the rotating shaft.

The rear seat flow path 80 may be connected to a rear seat duct (not illustrated) in the rear seat vent 84. Part of cold air, warm air, or mixed air in the case 10 may be guided to the rear seat of the vehicle interior through the rear seat duct to cool and/or heat a rear space of the vehicle interior.

In addition, the case 10 may include a floor vent 50 formed on at least one of the left or right sidewall 12 of the case 10 downstream from the evaporator 20 and the heating device 30 and may include a floor door 51 installed on the floor vent.

The floor vent 50 may discharge air toward feet of a passenger in the vehicle interior. To this end, a floor duct 59, formed to extend from the floor vent, may be connected to the floor vent.

In the air conditioning apparatus according to an example embodiment of the present disclosure, the floor vent 50 may be respectively formed on the left and right side walls 12 of the case 10. In addition, the floor vents may be disposed on upper sides of the left and right side walls. For example, the floor vents 50 may be respectively formed above the heating device 30, between the defrosting vent 60 and the face vent 70, on the left and right side walls 12 of the case 10.

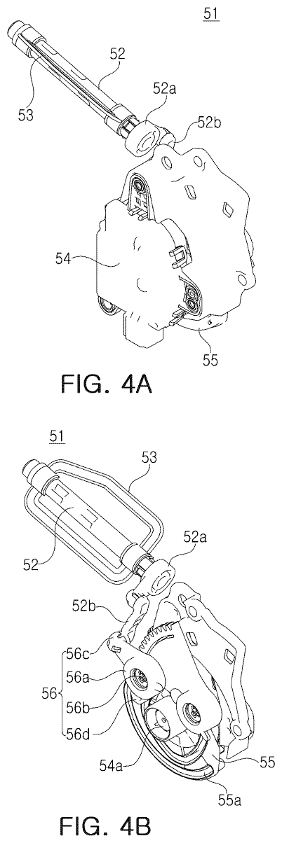

FIGS. 4A and 4B are perspective views of a floor door 51. The floor vents 50 are formed on the left and right side walls 12 of the case 10 and floor doors 51 are respectively installed in the floor vents. FIG. 4A illustrates a floor door in the floor vent on the left side wall and FIG. 4B illustrates a floor door in the floor vent on the right side wall.

The floor door 51 may adjust an amount of opening of the floor vent 50. Optionally, the floor door may be rotatably installed in the floor vent. To this end, the floor door may include a rotating shaft 52 rotatably installed in the floor vent and may include a door body 53 rotating according to rotation of the rotating shaft 52.

The rotating shaft 52 may be rotatably installed through the floor vent 50. The rotating shaft 52 may extend approximately in a front-to-rear direction of the vehicle.

The door body 53 may be in the form of an approximately flat plate, may have an area capable of closing the floor vent 50, may be installed in the floor vent via the rotating shaft 52, and may rotate in an arc around the rotating shaft. As a result, the floor door 51 may open or close the floor vent.

The drawings illustrate a rotatable flat plate-type door as the floor door 51, but a shape of the floor door is not necessarily limited thereto. For example, a dome-type door may be used. A sliding door may also be used.

The air conditioning apparatus according to an example embodiment of the present disclosure may further include an actuator 54, a cam member 55, and a lever 56 to drive the floor door 51.

The rotating shaft 52 of the floor door 51 may receive driving force from the actuator 54 to rotate. To this end, the rotating shaft 52 may include a fixed link 52a fixed to the rotating shaft and extending from the rotating shaft and may include a connection link 52b having one end hingedly connected to the fixed link 52a.

The fixed link 52a may be fixed to the rotating shaft 52 to rotate along with the rotating shaft 52. A protruding end of the fixed link 52a may be hingedly connected to the connection link 52b. One end of the connection link 52b may be hingedly connected to the fixed link 52a and the other end of the connection link 52b may be hingedly connected to the lever 56. As a result, the connection link 52b may transmit, to the fixed link 52a and the rotating shaft 52, driving force transmitted from the lever 56 to allow the door body 53 to rotate.

The actuator 54 may be installed on an external surface of a side wall 12 of the case 10 to provide driving force to the floor door 51. The actuator 54 may include a motor or a motor and gear module. A motor shaft or gear shaft may serve as an output shaft 54a transmitting driving force. The motor may be, for example, a servo motor or step motor capable of forward and reverse rotation. However, a configuration of the actuator is not necessarily limited to the above-described example.

The cam member 55 may be formed, for example, as a flat plate-type member and may be fixedly connected to the output shaft 54a of the actuator 54 to rotate in a forward direction or reverse direction along with the output shaft. At least one cam groove 55a having a predetermined trajectory may be formed on one surface of the cam member. The cam groove may have an approximately U-shape, but the present disclosure is not necessarily limited thereto.

The lever 56 may be rotatably installed on an external surface of the side wall 12 of the case 10 and may have one end connected to the floor door 51 and the other end connected to the cam member 55. As the other end moves on the cam member 55, the lever 56 may rotate.

The lever 56 may include a lever body 56a having an approximately V-shape, a lever shaft 56b provided in the middle of the lever body and connected to the case 10, a hinge portion 56c provided at one end of the lever body 56a and connected to the connection link 52b of the floor door 51, and a moving pin 56d provided at the other end of the lever body and inserted into the cam groove 55a of the cam member 55 to be movable along the cam groove 55a.

By configuring the cam member 55 and the lever 56 as described, when the output shaft 54a of the actuator 54 rotates, the cam member may rotate and the moving pin 56d of the lever may be moved while being guided along the cam groove 55a by rotation of the cam member.

Accordingly, the lever body 56a may rotate around the lever shaft 56b, and accordingly, the connection link 52b of the floor door 51, hingedly connected to the lever body, may allow the fixed link 52a and the rotating shaft 52 to rotate. As a result, the door body 53 may rotate.

Accordingly, in the air conditioning apparatus according to an example embodiment of the present disclosure, a floor flow path may be formed on the outside of the case 10. Accordingly, the air conditioning apparatus according to an example embodiment of the present disclosure may have a reduced size by almost half (49%), as compared to an air conditioning apparatus according to the related art. The air conditioning apparatus according to an example embodiment may also have a reduced weight by about 1 kg due to the reduced size.

In the air conditioning apparatus according to the related art, a partition wall may be installed in a case, a floor flow path may be formed in the case, a floor door may be disposed at an inlet of the floor flow path, and a floor vent may be disposed at an outlet of the floor flow path. Due to installation of the partition wall and formation of the floor flow path, the air conditioning apparatus may inevitably and unnecessarily have an increased size.

In addition, the floor door may be positioned on an upper portion and a rear portion of the case in the case, such that a defrosting door, a vent door, and a floor door may be sequentially arranged in a front-to-rear direction. Such an arrangement, along with installation of the partition wall, may serve as a factor that increases a size of the air conditioning apparatus unnecessarily.

In addition, the floor door may be disposed in the case, such that the floor door may be positioned upstream of the face vent disposed on an upper surface of the case in both a cooling flow path and a heating flow path.

Accordingly, when the floor door is opened along with the vent door for cooling, cold air in the cooling flow path may first be introduced into the floor flow path and discharged through the floor vent. Thus, a temperature of cold air discharged from the floor vent may become lower than a temperature of cold air discharged from the face vent. As a result, natural convection may be delayed or may not occur in a vehicle interior, adversely affecting cooling efficiency.

In the air conditioning apparatus according to an example embodiment of the present disclosure, the air inlet 11 may be formed on a lower surface of the case 10. Then the evaporator may be disposed on a lower portion of the case while being slightly inclined with respect to a horizontal plane.

Downstream of the evaporator 20, the temperature control door 40 may be positioned to open or close one of the cooling flow path C and the heating flow path H, or to adjust an opening amount or degree of the flow paths. The cooling flow path may be formed in a rear portion the case 10, as compared to the heating flow path, and the heating device 30 may be positioned in the heating flow path.

The defrosting vent 60 and the face vent 70 may be formed on an upper surface of the case 10 to be arranged side by side in a front-to-rear direction. In other words, the defrosting door 61 and the vent door 71 may be sequentially arranged in the front-to-rear direction.

As described above, the floor vent 50 may be respectively formed above the heating device 30, between the defrosting vent 60 and the face vent 70, on the left and right side walls 12 of the case 10. In other words, the floor vent may be positioned to be adjacent to a mixing region M in which warm air and cold air is mixed with each other or intersect to each other in the case.

The floor door 51 may be directly disposed on each floor vent 50. Here, a shaft line of the rotating shaft 52 of the floor door may intersect with shaft lines of a drive shaft of the defrosting door 61, a drive shaft of the vent door 71, and a drive shaft 42 of the temperature control door 40 at a right angle.

The air conditioning apparatus according to an example embodiment of the present disclosure may be configured as described herein. Thus, the floor door 51 may be positioned upstream of the face vent 70 in the heating flow path H and the floor door may be positioned downstream of the face vent in the cooling flow path C. For example, cold air, flowing from the cooling flow path C formed in a rear portion of the case 10 in the case 10, may first be discharged through the face vent.

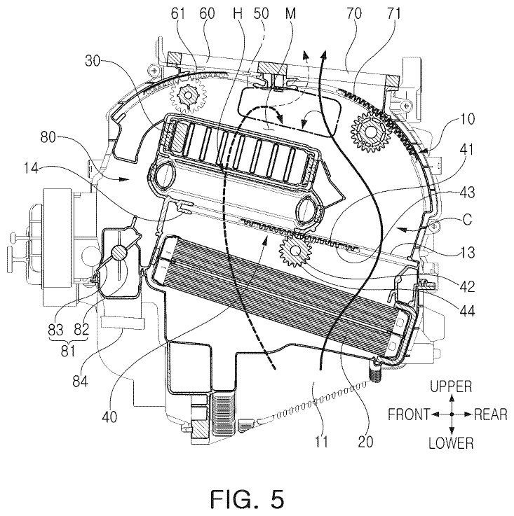

FIG. 5 is a diagram illustrating operation of an air conditioning apparatus according to an example embodiment of the present disclosure.

When cooling is selected, an upstream side of the heating device 30 may be closed by the temperature control door 40. Air introduced into the case 10 through the air inlet 11 may pass through the evaporator 20 and may then flow along the cooling flow path C to be supplied to each vent.

When heating is selected, the upstream side of the heating device 30 may be opened by the temperature control door 40. Air introduced into the case 10 through the air inlet 11 may pass through the heating device 30 following the evaporator 20 and may then flow along the heating flow path H to be supplied to each vent.

When a mixing mode is selected, the upstream side of the heating device 30 may be partially opened by the temperature control door 40. Thus, cold air passing through the evaporator 20 and warm air passing through the heating device 30 may be mixed with each other in the mixing region M in the case 10 to generate mixed air at a desired temperature, and may be supplied to each vent.

For example, when a vent mode is selected during cooling, the upstream side of the heating device 30 may be closed by the temperature control door 40, the face vent 70 may be opened by the vent door 71, and the defrosting vent 60 and the floor vent 50 may be closed by corresponding doors. As a result, cool air may be supplied to the face vent.

In addition, when a floor mode is selected during heating, the upstream side of the heating device 30 may be opened by the temperature control door 40 and the floor vent 50 may be fully opened by the floor door 51. As a result, warm air may be supplied to the floor vent.

A bi-level mode may be selected in which air is discharged to each of an upper portion and a lower portion of the vehicle interior through the face vent 70 and the floor vent 50. In this case, corresponding vents may be opened by the vent door 71 and the floor door 51 such that air may be supplied to the face vent and the floor vent approximately half and half.

When the floor door 51 is opened along with the vent door 71 for cooling, the floor door may be positioned downstream of the face vent 70. Thus, a temperature of cold air discharged from the floor vent 50 may become higher than a temperature of cold air discharged from of the face vent 70. As a result, natural convection may smoothly occur in the vehicle interior, resulting in improved cooling efficiency.

When the floor door 51 is opened along with the vent door 71 for heating, the floor door may be positioned upstream of the face vent 70. Thus, a temperature of warm air discharged from the floor vent 50 may become higher than a temperature of warm air discharged from the face vent 70. Accordingly, natural convection may smoothly occur in the vehicle interior, resulting in improved heating efficiency.

In the air conditioning apparatus according to an example embodiment of the present disclosure, a partition wall and a floor flow path may be removed in the case 10. Thus, the air conditioning apparatus may have a reduced size and weight as compared to the air conditioning apparatus according to the related art, thereby reducing costs required to manufacture a product.

In addition, in the air conditioning apparatus according to an example embodiment of the present disclosure, a floor flow path may be omitted from the case 10 to minimize a flow path, thereby reducing resistance to air flow in the case 10 and increasing an air volume, while also reducing noise by about 1.1 dB and reducing power consumption by about 5%, resulting in improved product quality.

While example embodiments have been illustrated and described above, it should be apparent to those of ordinary skill in the art that modifications and variations can be made to the embodiments illustrated and described herein without departing from the scope of the present disclosure as defined by the appended claims.

The example embodiments described herein are to be considered in a descriptive sense only, and not for purposes of limitation. Therefore, the scope of the present disclosure is defined not by the detailed description, but by the claims and their equivalents. All variations within the scope of the claims and their equivalents are to be construed as being included in the present disclosure.

What is claimed is:

1. An air conditioning apparatus comprising:
a case having an air inlet;
an evaporator;
a heating device disposed downstream of the evaporator; and
a temperature control door installed between the evaporator and the heating device and configured to adjust air flow downstream of the evaporator,
wherein the case includes
a defrosting vent and a face vent, sequentially arranged in a front-to-rear direction of the case, and
a floor vent formed between the defrosting vent and the face vent on at least one of a left side wall or a right side wall of the case.

2. The air conditioning apparatus of claim 1, wherein:
the case includes a floor door installed on the floor vent; and
the floor vent is disposed downstream of the evaporator and the heating device.

3. The air conditioning apparatus of claim 2, wherein the floor door includes:
a rotating shaft passing through the floor vent and rotatably installed; and
a door body rotating according to rotation of the rotating shaft,
wherein the rotating shaft is disposed to extend in the front-to-rear direction.

4. The air conditioning apparatus of claim 3, further comprising:
an actuator installed on an external surface of the case;
a rotatable cam member connected to the actuator; and
a lever rotatably installed on an external surface of the case and having one end connected to the floor door and another end connected to the cam member.

5. The air conditioning apparatus of claim 4, wherein:
the cam member is fixedly connected to an output shaft of the actuator and rotates along with the output shaft; and
the cam member has at least one cam groove having a trajectory.

6. The air conditioning apparatus of claim 5, wherein the rotating shaft includes:
a fixed link fixed to the rotating shaft and extending from the rotating shaft; and
a connection link having one end hingedly connected to the fixed link and another end hingedly connected to the lever, such that the connection link transmits, to the fixed link and the rotating shaft, a driving force transmitted from the lever.

7. The air conditioning apparatus of claim 6, wherein the lever includes:
a lever body;
a lever shaft provided in the middle of the lever body and connected to the case;
a hinge portion provided at one end of the lever body and connected to the other end of the connection link; and
a moving pin provided at the other end of the lever body and inserted into the cam groove to be movable along the cam groove.

8. The air conditioning apparatus of claim 2, wherein the heating device, downstream of the evaporator, defines a heating flow path covered by the heating device and a cooling flow path without the heating device.

9. The air conditioning apparatus of claim 8, wherein:
when the temperature control door opens an upstream portion of the heating device downstream of the evaporator, air introduced into the case flows along the heating flow path; and
when the temperature control door closes the upstream portion of the heating device downstream of the evaporator, air introduced into the case flows along the cooling flow path.

10. The air conditioning apparatus of claim 8, wherein the floor door is positioned upstream of the face vent in the heating flow path and is positioned downstream of the face vent in the cooling flow path.

11. The air conditioning apparatus of claim 3, wherein the case includes:
a defrosting door configured to adjust an opening amount of the defrosting vent; and
a vent door configured to adjust an opening amount of the face vent.

12. The air conditioning apparatus of claim 11, wherein:
the temperature control door, the defrosting door, and the vent door respectively include a drive shaft; and
a shaft line of the rotating shaft intersects a shaft line of the drive shafts of the temperature control door, the defrosting door, and the vent door at a right angle.

13. The air conditioning apparatus of claim 11, wherein:
at least one of the temperature control door, the defrosting door, or the vent door is slidably installed; and
at least one of the temperature control door, the defrosting door, or the vent door includes a rack and pinion mechanism.

14. The air conditioning apparatus of claim 1, wherein:
a floor duct is connected to the floor vent; and
a floor flow path is formed on the outside of the case.

15. The air conditioning apparatus of claim 1, wherein:
the air inlet is formed on a lower surface of the case; and
the evaporator is disposed to be inclined with respect to the lower surface of the case.
